(19) United States
(12) Patent Application Publication
(10) Pub. No.: US 2017/0116648 A1
(43) Pub. Date: Apr. 27, 2017

(54) Online-Advertising Script Service with Dynamic and Static Insertion

(71) Applicant: Optmyzr Inc., Foster City, CA (US)

(72) Inventors: Frederick Vallaeys, Foster City, CA (US); Manas Garg, Hyderabad (IN); Geetanjali Tyagi, Hyderabad (IN); Shashank Tiwari, Hyderabad (IN)

(21) Appl. No.: 15/331,692

(22) Filed: Oct. 21, 2016

Related U.S. Application Data
(60) Provisional application No. 62/245,258, filed on Oct. 22, 2015.

(51) Int. Cl. G06Q 30/02; H04L 29/08

(52) U.S. Cl. CPC G06Q 30/0276; G06Q 30/0277; H04L 67/02

(57) ABSTRACT

In one embodiment, a method includes accessing structured data associated with an online-advertising campaign, wherein the structured data includes header data options and parameter data options; sending to a client device for display an advertising-campaign template that includes text input fields corresponding to the structured data; receiving input from a user of a selection of at least one of the header data options, and for each of the selected header data options, a selection of at least one of the parameter data options; and automatically generating a script that includes the selection of the header data options and the parameter data options, and wherein the script provides instructions to display a particular advertisement on a search-results interface on a webpage.

### BACKGROUND

An online-advertising service like Google AdWords enables advertisers to compete to display advertising copy to users based on predetermined keywords (usually set by the advertisers) that link the copy to the content of web pages (which may include search results) shown to users.

Web pages from Google and other websites allow the online advertising service to select and display the advertising copy, and advertisers pay when users divert their browsing to seek more information about the copy displayed. For example, with the online-advertising service, an advertiser may create an advertisement that indicates what the advertiser offers. The advertiser may then choose one or more keywords that will cause the advertisement to be shown in Google or other search results. The advertiser may set a daily or other budget for displays of the advertisement. When search terms entered by a user for a Google or other web search match the keywords associated with the advertisement, the advertisement may appear above or next to search results shown to the user. The user may then select the advertisement and be directed to a website of the advertiser. The online-advertising service may include features that enable advertisers to target by website type, audience type, or remarketing, helping them to reach more relevant users and more relevant web pages. The online-advertising service may also provide analytic tools to advertisers. Such tools may, for example, track and show an advertiser how many people noticed advertising copy of the advertiser and what percentage click-through to a website of the advertiser or otherwise contact the advertiser.

### SUMMARY OF PARTICULAR EMBODIMENTS

In particular embodiments, an advertising-analytics service for advertisers and marketers may facilitate the use of one or more online-advertising-service scripts provided by an online-advertising service (e.g., Google Adwords). Such a service may provide an advertiser with an easy-to-use form-based user interface (“UP”) that solicits and receives settings and other inputs from the advertiser and then generates code for an online-advertising-service script based on those inputs. Typically, scripts for an online-advertising service (and their settings) are maintained on the website of the online-advertising service and modifications to the settings of a script must be done by changing the code of the script on the website. In particular embodiments, a script service for advertisers may move all or some of the settings of one or more scripts for an online advertising service to an easy-to-use form-based UI hosted by the script service. Rather than having to know how to write JavaScript to modify the functionality of a script, a user need only know how to fill out a web-based form to change what a script does.

### BRIEF DESCRIPTION OF THE DRAWINGS

FIG. 1 illustrates an example advertising-analytics service in an example network environment.

FIG. 2 illustrates an example script-service interface.

FIG. 3 illustrates another example script-service interface.

FIG. 4 illustrates an example structured-data interface.

FIG. 5 illustrates another example script-service interface.

FIG. 6 illustrates another example script-service interface.

FIG. 7 illustrates another example script-service interface.

FIG. 8 illustrates an example computer system.

### DESCRIPTION OF EXAMPLE EMBODIMENTS

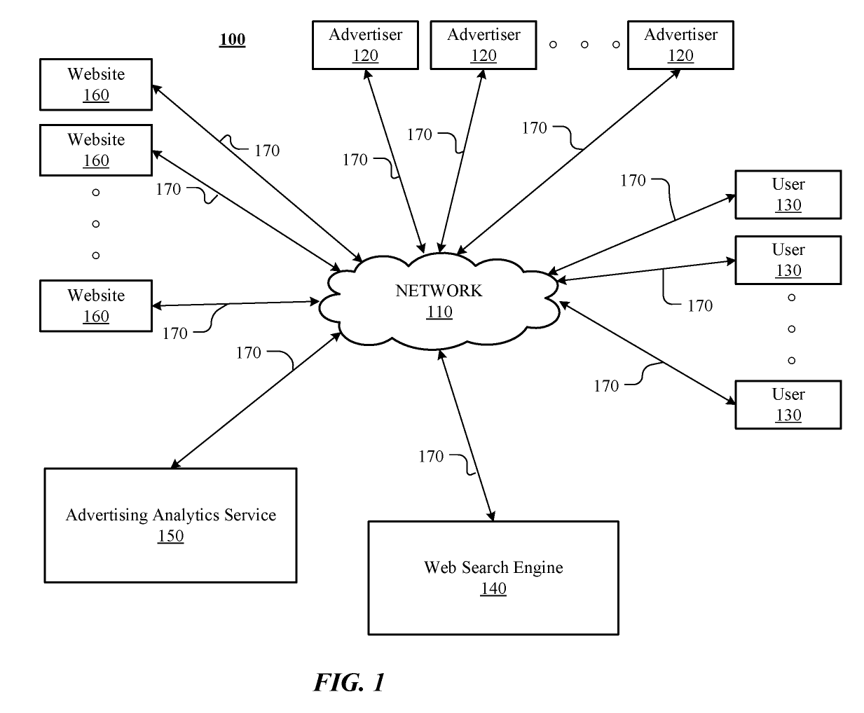

FIG. 1 illustrates an example advertising-analytics service in an example network environment 100. Network environment 100 includes one or more advertisers 120, one or more users 80, a web search engine 140 (e.g., GOOGLE), advertising-analytics service 150, and one or more websites 160 connected to each other by network 110. Although FIG. 1 illustrates network environment 100 as including a particular number of particular entities in m a particular arrangement, this disclosure contemplates any suitable number of any suitable entities in any suitable arrangement. As an example and not by way of limitation, two or more of advertisers 120, users 80, web search engines 140, advertising-analytics service 150 and websites 160 may be connected to each other directly, bypassing network 110. As another example, two or more of advertisers 120, users 80, web search engines 140, advertising-analytics service 150 and websites 160 may be physically or logically co-located with each other in whole or in part.

This disclosure contemplates any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular-technology-based network, or a combination of two or more of these. Network 110 may include one or more networks 110.

One or more links 170 couple advertisers 120, users 80, web search engines 140, advertising-analytics service 150, and web sites 160 to network 110. This disclosure contemplates any suitable links 170. In particular embodiments, one or more links 170 include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 170 each include an ad hoc network, an intranet, an extranet, a VPN, a LAN, a WLAN, a WAN, a WWAN, a MAN, a portion of the Internet, a portion of the PSTN, a cellular-technology-based network, a satellite-communications-based network, another link 170, or a combination of two or more such links 170. Links 170 need not necessarily be the same throughout network environment 100. One or more first links 170 may differ in one or more respects from one or more second links 170.

A user 80 may be an individual (human user), an entity (e.g., an enterprise, business, or third-party application), or a group (e.g., of individuals or entities) that uses the Internet. User 80 may browse the Internet and visit websites either by entering a uniform resource locator (URL) into an Internet browser (e.g., CHROME), or by entering a search query into a web search engine. If user 80 enters a search query into a web search engine 140, the web search engine 140 may search the Internet for web pages (hosted by websites 160) that are relevant to the search query. Web search engine 140 may then display a search results page comprising a list of organic and non-organic search results. The organic search results may be references that the web search engine has identified as being particularly relevant to the search query entered by user 80. The non-organic search results may be paid advertisements or sponsored listings that an online advertising service (e.g., GOOGLE ADWORDS) has identified after calculating the “Adrank” of several paid advertisements. The Adrank of a particular advertisement determines its position on the search results page. It is calculated by multiplying the bid amount (often referred to as a “maximum cost per click” (max. CPC)) with the advertisement's keyword Quality Score. Thus, Adrank=max CPC×Qualityscore. An advertisement's Quality Score depends on several factors, including keywords associated with the advertisement, the click-through rate (CTR) for various components of the advertisement or account (e.g., CTR of keywords, CTR of the ads and keywords for the account, CTR of a specific URL), the quality of a landing page associated with the advertisement, the relevancy of the keywords to the search query, geographic performance, and the type of device on which the search was performed. Thus, Adrank=max CPC×Qualityscore. Advertisements with a higher Adrank are placed higher on the search results page. Thus, advertisers 120 may wish to optimize their Adrank in order to receive a higher ad position and ultimately maximize conversions. A conversion may occur when a user 80 switches from being a site visitor into a paying customer.

The online advertising service may be operated by web search engine 140. Advertiser 120 may have an online account with the online advertising service to place non-organic search results on the search results page. In addition to placing advertisements based on Adrank, the online advertising service may additionally provide data to advertiser 120 so that advertiser 120 may make better advertising decisions. Such advertising decisions may comprise selecting more relevant keywords, changing bid amounts for particular keywords, changing bid amounts based on the day of the week or the time of the day, changing bid amounts based on the geographic region of a search query, among others. Often, the data provided by the online advertising service may be complex or disorganized. Advertising-analytics service 150 may aid in the analysis of such advertising information by providing tools to advertisers 120 who subscribe to advertising-analytics service 150. Herein, such advertisers 120 may be referred to as subscribers. The tools provided to the subscribers by advertising-analytics service 150 may help the subscribers interpret the advertising information by providing visualizations of various metrics. The tools may also provide one or more recommendations for optimizations a subscriber may make to its advertising strategy. In particular embodiments, the advertising-analytics service 150 may provide one or more interfaces between the web search engine 140 and the subscriber. This interface may be provided to make it easier for subscribers to interact with the advertising information and make changes to their account with the online advertising service. These tools, recommendations, and interfaces will be discussed in more detail below. Example metrics that advertising-analytics service 150 may provide to a subscriber are discussed in the following table:

TABLE 1
Example Metrics

| Metric | Description |
|---|---|
| number of | The number of impressions may be number of single |
| impressions | displays of a non-organic search result on a search |
| | results page. |
| average cost | The average cost per click may be the average amount |
| per click | charged to advertiser 120 every time a user clicks on a |
| | non-organic search result. |
| number of | The number of clicks may be the number of times a non- |
| clicks | organic search result has been clicked on by users 80. |
| click-through | The click-through rate (CTR) may be the proportion of |
| rate | users who click on a particular non-organic search result |
| | compared to the total number of users who view that |
| | non-organic search result. |
| cost | The cost may be the total cost of a particular non-organic |
| | search result, or the cost of achieving a conversion. |
| average | The average position may be the average order in which a |
| position | particular non-organic search result appears on a search |
| | results page in relation to other non-organic search results. |
| | A position of “1” means that the non-organic search result |
| | is the first on the page. |
| impression | Impression share may be the number of actual impressions |
| share | divided the number of eligible impressions. An advertise- |
| | ment is eligible for an impression if at least some of its |
| | keywords match at least some of the n-grams of a search |
| | query. |
| conversion | Conversion value may be a set amount of money for a |
| value | given conversion. For example, a purchase conversion |
| | may be worth 625. As another example, a newsletter |
| | signup may be worth 65. |
| conversion | Conversion value/cost may be the ratio of the value |
| value/ | received from a conversion to the cost of achieving |
| cost | that conversion. |
| conversion | Conversion value per click may be the value of a conver- |
| value | sion divided by the number of clicks a non-organic |
| per click | search result achieved. |
| converted | Converted clicks may be the number of clicks that convert |
| clicks | within an advertisers chosen conversion window. If a user |
| | makes two separate purchases after clicking on an |
| | advertisement, the user will register as one conversion |
| | click. |
| cost per | Cost per conversion click may be the cost of an advertise- |
| conversion | ment divided by the number of converted clicks. This may |
| click | also be referred to as “cost per acquisition” |
| conversion | Conversion rate may be the total number of conversions |
| rate | divided by the total number of ad clicks that can be |
| | tracked to a conversion during the same time period. |

Although Table 1 describes particular metrics that advertising-analytics service 150 may provide to a subscriber, this disclosure contemplates any suitable metrics that advertising-analytics service 150 may provide to a subscriber. Moreover, although Table 1 provides particular definitions of particular metrics that advertising-analytics service 150 may provide to a subscriber, this disclosure contemplates any suitable definitions of any suitable metrics that advertising-analytics service 150 may provide to a subscriber.

In particular embodiments, advertising-analytics service 150 for advertisers and marketers may facilitate the use of online-advertising-service scripts provided by an online-advertising service. Such a service may provide an advertiser with an easy-to-use form-based UI that solicits and receives settings and other inputs from the advertiser and then generates code for an online-advertising-service script based on those inputs. Typically, scripts for an online-advertising service (and their settings) are maintained on the website of the online-advertising service and modifications to the settings of a script must be done by changing the code of the script on the website. In particular embodiments, advertising-analytics service 150 may move all or some of the settings of one or more scripts for an online advertising service to an easy-to-use form-based UI hosted by advertising-analytics service 150. Rather than having to know how to write JavaScript to modify the functionality of a script, a user need only know how to fill out a web-based form to change what a script does. Although this disclosure describes using online-advertising-service scripts in a particular manner, this disclosure contemplates using online-advertising-service scripts in any suitable manner.

In particular embodiments, advertising-analytics service 150 may enable users to maintain different settings to be applied to different accounts with an online-advertising service. Normally, that would entail making multiple copies of the same script. With the script service maintained by advertising-analytics service 150, the user may fill out a form from every account that the user wants the script to run on. Advertising-analytics service 150 may provide generic code that is added to the accounts, and, whenever the script runs, advertising-analytics service 150 may give the online-advertising service the correct settings for the account so that the script can do different things for every account.

In particular embodiments, advertising-analytics service 150 may store the code that executes in an online-advertising service account. As a result, advertising-analytics service 150 may make changes to the code to improve it and users may not need to update anything on their end; they will always be running on the latest code. In particular embodiments, advertising-analytics service 150 may collect logs of all script executions on its website, which may make it easier for users to stay informed about changes to their accounts. Although this disclosure describes storing code in a particular manner, this disclosure contemplates storing code in any suitable manner.

In particular embodiments, advertising-analytics service 150 may provide generic code for multiple scripts. When this code is added to an online-advertising-service account, it may not have to be updated. Users may make changes to what the code does by updating the settings in the form-based UI of the script service. The script service may make changes to the functionality of the code and a user may automatically be using the latest version every time the user runs a script through the script service. Although this disclosure describes updating generic code in a particular manner, this disclosure contemplates updating generic code in any suitable manner.

In particular embodiments, an example user flow of an example form-based UI of advertising-analytics service 150 may follow the following steps. First, the user may go to a website of advertising-analytics service 150 and use a form to choose what a script will do. This may be repeated for additional online-advertising-service-accounts or settings may be copied using the functionality of advertising-analytics service 150. Next, the user may receive from advertising-analytics service 150 a generic online-advertising-service script. Next, the user may copys-and-paste this script into the user's online-advertising service account. The script may be put in an individual account or put in a master account for multiple account. Next, the user may set a schedule for the script to run (e.g. a Cron job). Next, the user may retrieve results from execution of the script on the website of the script service. Next, the user may make changes to the functionality of the script (if desired) using the same form as in the first step. After the settings are changed, the script need not be reinstalled. Although this disclosure contemplates a form-based user flow in a particular manner, this disclosure contemplate a form-based user flow in any suitable manner.

In particular embodiments, when a script from advertising-analytics service 150 runs on an online-advertising service, the script may tell the advertising-analytics service 150 that it wants to run on a particular online-advertising-service account. Advertising-analytics service 150 then returns the settings for that account for the script and the generic code associated with the script. The online-advertising service may then execute the script. Advertising-analytics service 150 may then capture logs from the online-advertising service.

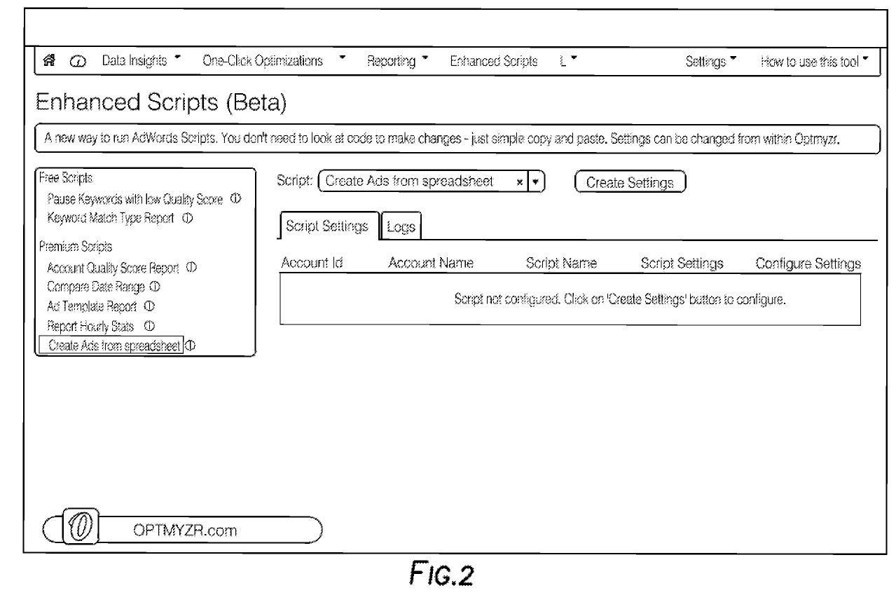

FIG. 2 illustrates an example script-service interface. In particular embodiments, a script-service interface may be initiated by selecting “Create Ad from Spreadsheet” as depicted in FIG. 2. In particular embodiments, a user may use a web browser to navigate to a script service hosted by advertising-analytics service 150, and the user may select the account in which she wants to create an advertisement. In particular embodiments, the user may proceed to Enhanced Scripts, and in Enhanced Scripts, she may find the script “Create Ad from a Spreadsheet.” The user may select that option and then select “Create Settings.” This disclosure explains how to take the data source, and how to create ads, keywords, ad groups and campaigns based on a template. Although this disclosure describes providing a user with a scripts-service interface in a particular manner, this disclosure contemplates providing a user with a scripts-service interface in any suitable manner.

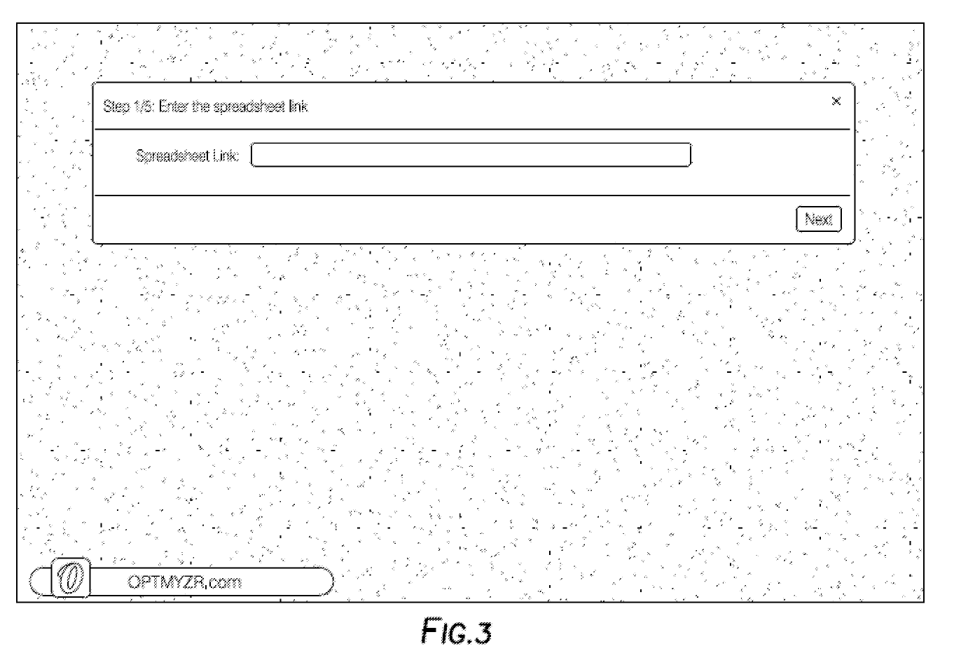

FIG. 3 illustrates another example script-service interface. In particular embodiments, a user may link to a spreadsheet to upload structured data, For example. user may ink to a Google spreadsheet. As illustrated in FIG. 3, a user may enter a URL into the script-service interface. As an example and not by way of limitation, a user may paste a URL of a spreadsheet that has all of a user's structured data into a text field. The spreadsheet may be any form of structured data. Although this disclosure describes providing a script-service interface in a particular manner, this disclosure contemplates providing a script-service interface in any suitable manner.

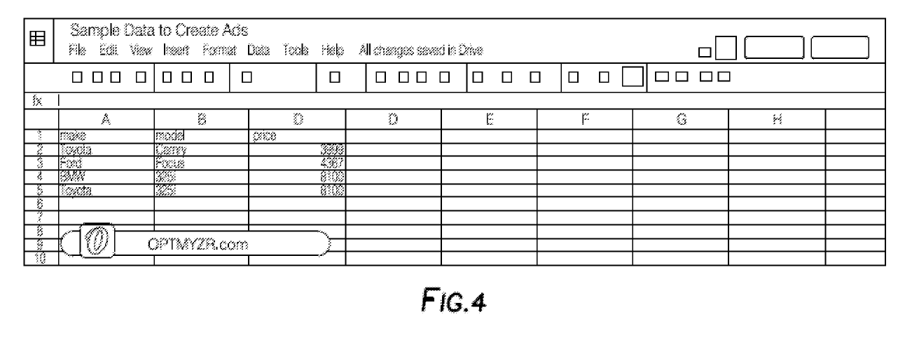

FIG. 4 illustrates an example structured-data interface comprising an example spreadsheet with a user's structured data. As an example and not by way of limitation, a car dealership may sell different makes and models of cars, and may also have different price points for various cars. The spreadsheet may not be limited to three dynamic insertion parameters; the user may add as many as she wants. As an example and not by way of limitation, the user may also include a column indicating inventory. Each header may become available as a dynamic insertion parameter in the script. The user may then copy the link of the spreadsheet and paste it into the script, and click “next.” If necessary, the user may authorize access to the script. The scripts service may process the spreadsheet and proceed to step 2. Although this disclosure describes providing a structured-data interface in a particular manner, this disclosure contemplates providing a structured-data interface in any suitable manner.

In particular embodiments, the user may define where the new advertisements will be stored—in which campaigns and which ad groups. The user may select existing campaigns or create a new campaign. As an example and not by way of limitation, if the user already has a campaign for used cars, the user may simply type in “Used Cars” in the “Existing Campaign Name” field, and then all the new ads may go to that existing campaign. Although this disclosure describes storing advertisements in a particular manner, this disclosure contemplates storing advertisements in any suitable manner.

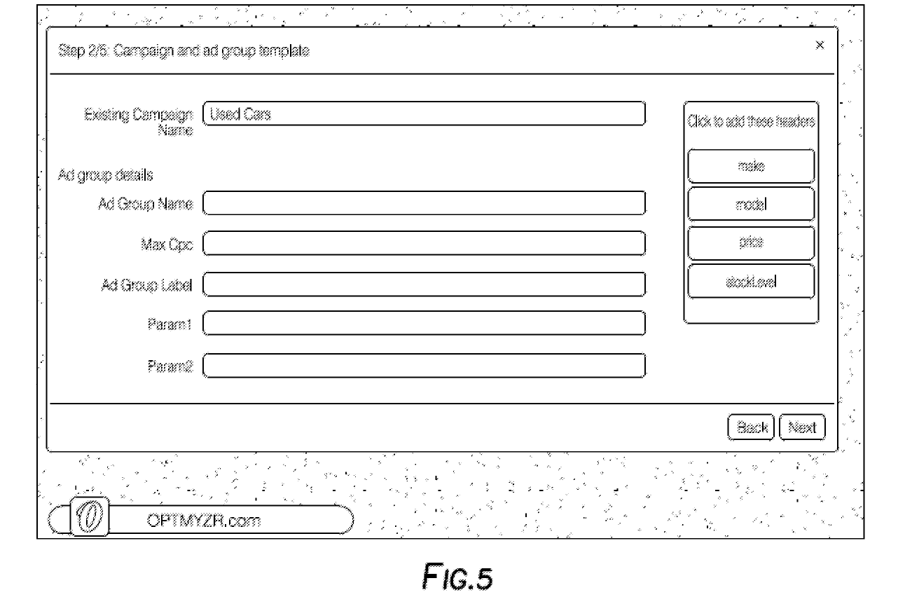

FIG. 5 illustrates another example script-service interface. In particular embodiments, the user may use dynamic insertion based on the headers located in the structured data. Dynamic insertion may be understood to mean that as the entries in the spreadsheet change, their associated scripts may be updated to reflect the changes in the spreadsheet. As FIG. 5 illustrates, the example headers at the right may be the same as the header rows in the spreadsheet. The user may either click on these to dynamically insert them, or the user may type them in. Next, the user may decide how to structure the ad groups. As an example and not by way of limitation, the user may make a different ad group for every combination of “make” plus “model” by combining the make of the car with the model of the car. This may become the user's ad group name. The user may accomplish this by either clicking on the “make” and “model” headers, or by typing “[make] [model]” into the ad group Name field. If the ad group doesn't exist yet, advertising-analytics service 150 may create it. If, on the other hand, the user just wants a separate ad group for every make (e.g., an ad group for Toyota, another ad group for Ford, etc.) then the user may just include “make.” The user may also include static text like “cars.” For example, typing “[make] cars” into the “Ad Group Name” field may return “Toyota Cars,” “Ford Cars,” and so on. The user may also set the max cost per click (CPC) for this ad group. The user may also assign a label to the “Ad Group Label” field. It can be a static label that can simply be typed into the field, or it can be a dynamic label, selected from the list of headers. Param1 or Param2 are the dynamic insertion parameters made available by google specifically to be used with numeric values. These are ideal if a user desires to keep the same ads but also wants to change the price, or the quantity. Therefore, Param1 and Param2 may be appropriate for the last two headers, price and stockLevel. The user may make Param1 a particular price, and may make Param2 the stock level. Once completed, the user may continue on to the next step. Although this disclosure describes a script-service interface in a particular manner, this disclosure contemplates script-service interfaces in any suitable manner.

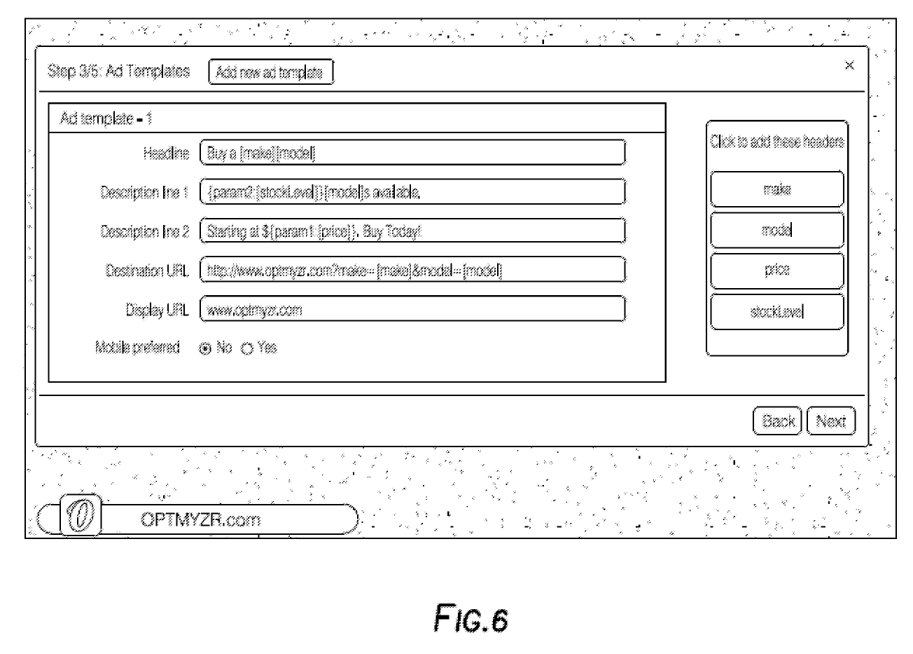

FIG. 6 illustrates another example script-service interface. In particular embodiments, the user may define what the advertisement text will be that is being added to the new advertisement groups or the already existing advertisement groups. An example of advertisement text may be seen in FIG. 6. In particular embodiments, the advertisement text may be based on the dynamic insertion data that that the user has made available through her structured data (e.g., spreadsheet). As the user clicks on the header boxes on the right side of the FIG. 6, the dynamic insertion headers may become available. Although this disclosure describes a script-service interface in a particular manner, this disclosure contemplates script-service interfaces in any suitable manner.

In particular embodiments, hard coded text may be added (i.e., static insertion). For example, the text could say “buy a” and then the user may insert a dynamic insertion of make and model. This may result in, for example, “Buy a Toyota Camry,” based on the line in the spreadsheet. In “Description line 1” the following may be entered: “{param2:[stockLevel]} [model]s available.” Here, the stock level may be dynamically inserted and the model may be dynamically inserted. An “s” has been statically inserted after the dynamically inserted model, so as to show plurality. The above text in “Description line 1” might return a line that says “17 Camrys available.” In “Description line 2” the following may be typed: “Starting at ${param1:[price]}. Buy Today!” Here, the price has been dynamically inserted, and the rest of the text may be statically inserted. These may be dynamic insertion parameters from Google and may be used for numerical values that dynamically change. As an example and not by way of limitation, the above text in “Description line 2” may return a line that says “Starting at $12,500. Buy Today!” In particular embodiments, for destination URL, the user may use dynamic insertion to construct the URL that takes a consumer to the correct make and model for the car on the user's website. In particular embodiments, the user may select whether or not to make the script mobile preferred. The user may want to run multiple ad texts in each ad group. This may be accomplished by clicking on “Add new ad template.” Although this disclosure describes inserting static and dynamic data in a particular manner, this disclosure contemplates inserting static and dynamic data in any suitable manner.

In particular embodiments, the user may also create a default advertisement text which has no dynamic insertion parameters. This may be necessary because some online advertising services may have word limits or other inhibiting settings on advertisement campaigns. By creating a default ad text, the user may increase the likelihood of creating ad text that fits within the limits for every ad group. Although this disclosure describes providing static insertion parameters in a particular manner, this disclosure contemplates providing static insertion parameters in any suitable manner.

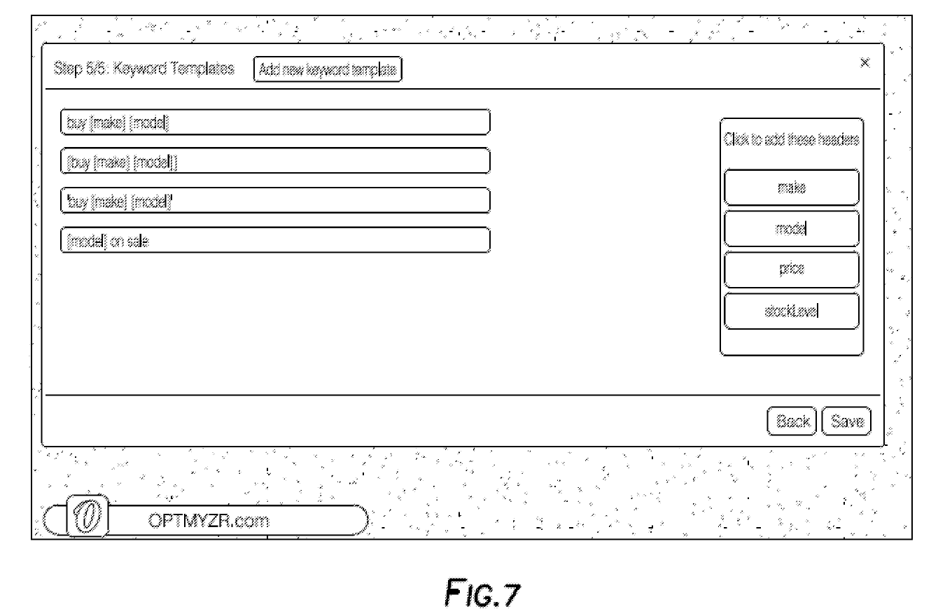

FIG. 7 illustrates another example script-service interface. In particular embodiments, the user may create a keyword template. In particular embodiments, the user may use dynamic insertion parameters. As an example and not by way of limitation, the user may enter “buy a [make] [model]” to create a line that says, for example, “buy a Ford Focus.” To add more keywords, the user may click the blue button, “Add new keyword template.” In the resulting text box, the user may either type in a static or dynamic keyword, or select from the headers that appear on the right. As soon as the user selects the text box, dynamic insertion parameters may become available. If the user wants to use different match types, she may copy that keyword and put the notation for an exact match around it. The user may have one word keyword, and the user may also put a notation for a phrase match keyword. The user may want to make other keywords, such as simply “[model] on sale.” The result would be “Focus on sale” or “Camry on sale.” Then the user may click “save.” That may complete the process. The user may next copy and paste the downloaded script into her online advertising service account (e.g., a Google AdWords account). The user may schedule the script to run as frequently as she wants. When the user updates the spreadsheet with new info, for example, the user may add a new car for sale, the next time the script runs, the program may incorporate at the data, and it may create the new ad groups with the new keywords and the new ad texts that the user has specified in the spreadsheet. Although this disclosure describes creating a keyword template in a particular manner, this disclosure contemplates creating a keyword template in any suitable manner.

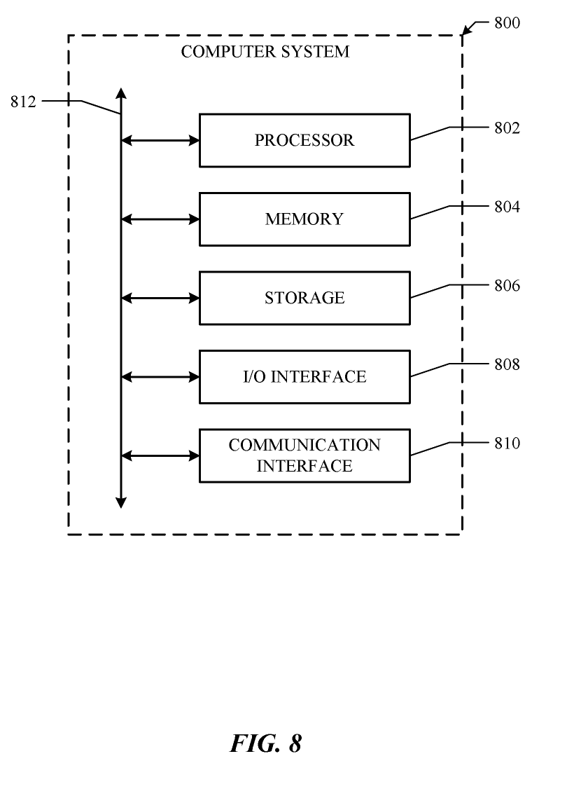

FIG. 8 illustrates an example computer system 800. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate.

Although this disclosure describes and illustrates a particular communication interface, this disclosure contemplates any suitable communication interface.

In particular embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Additionally, although this disclosure describes or illustrates particular embodiments as providing particular advantages, particular embodiments may provide none, some, or all of these advantages.

1. A method comprising:
by a computing device, accessing structured data associated with an online-advertising campaign, wherein the structured data comprises one or more header data options and one or more parameter data options;
by the computing device, sending to a client device for display an advertising-campaign template comprising a plurality of text input fields corresponding to at least some of the structured data;
by the computing device, receiving input from a user that comprises:
a selection of at least one of the header data options or a first text string input into a first text input field of the plurality of text input fields that specifies at least one of the header data options, and
for each of the selected header data options, a selection of at least one of the parameter data options or a second text string input into a second text input field of the plurality of text input fields that specifies at least one of the parameter data options; and
by the computing device, automatically generating a script, wherein the script comprises the selection of the at least one of the header data options and the selection of the at least one of the parameter data options, and wherein the script provides instructions to display a particular advertisement on a search-results interface on a webpage.

2. The method of claim 1, wherein the advertising-campaign template further displays an option for the user to select an existing ad campaign or a new ad campaign.

3. The method of claim 1, wherein automatically generating the script further comprises:
receiving an indication that the one or more header data options or the one or more parameter data options has been changed; and
updating the script based on the changed header data options or the changed parameter data options.

4. The method of claim 1, further comprising receiving input from a user comprising a third text string input into a third text input field of the plurality of text input fields that comprises text to be statically inserted into the particular advertisement.

5. The method of claim 1, wherein the parameter data options comprise one or more of: a model type, an inventory number, or a price.

6. The method of claim 1, wherein the advertising-campaign template is associated with a plurality of online advertisements, wherein each online advertisement is associated with the same online advertising campaign.

7. The method of claim 1, wherein the text input fields comprise one or more of:
a headline;
an Ad Group Name;
a Max Cost-per-click;
an Ad Group Label; or
a destination URL.

8. One or more computer-readable non-transitory storage media embodying software that is operable when executed to:
access structured data associated with an online-advertising campaign, wherein the structured data comprises one or more header data options and one or more parameter data options;
send to a client device for display an advertising-campaign template comprising a plurality of text input fields corresponding to at least some of the structured data;
receive input from a user that comprises:
a selection of at least one of the header data options or a first text string input into a first text input field of the plurality of text input fields that specifies at least one of the header data options, and
for each of the selected header data options, a selection of at least one of the parameter data options or a second text string input into a second text input field of the plurality of text input fields that specifies at least one of the parameter data options; and
automatically generate a script, wherein the script comprises the selection of the at least one of the header data options and the selection of the at least one of the parameter data options, and wherein the script provides instructions to display a particular advertisement on a search-results interface on a webpage.

9. The media of claim 8, wherein the advertising-campaign template further displays an option for the user to select an existing ad campaign or a new ad campaign.

10. The media of claim 8, wherein automatically generating the script further comprises:
receiving an indication that the one or more header data options or the one or more parameter data options has been changed; and
updating the script based on the changed header data options or the changed parameter data options.

11. The media of claim 8, wherein the software is further operable when executed to receive input from a user comprising a third text string input into a third text input field of the plurality of text input fields that comprises text to be statically inserted into the particular advertisement.

12. The media of claim 8, wherein the parameter data options comprise one or more of: a model type, an inventory number, or a price.

13. The media of claim 8, wherein the advertising-campaign template is associated with a plurality of online advertisements, wherein each online advertisement is associated with the same online advertising campaign.

14. The media of claim 8, wherein the text input fields comprise one or more of:
a headline;
an Ad Group Name;
a Max Cost-per-click;
an Ad Group Label; or
a destination URL.

15. A system comprising: one or more processors; and a memory coupled to the processors comprising instructions executable by the processors, the processors being operable when executing the instructions to:
access structured data associated with an online-advertising campaign, wherein the structured data comprises one or more header data options and one or more parameter data options;
send to a client device for display an advertising-campaign template comprising a plurality of text input fields corresponding to at least some of the structured data;
receive input from a user that comprises:
a selection of at least one of the header data options or a first text string input into a first text input field of the plurality of text input fields that specifies at least one of the header data options, and
for each of the selected header data options, a selection of at least one of the parameter data options or a second text string input into a second text input field of the plurality of text input fields that specifies at least one of the parameter data options; and
automatically generate a script, wherein the script comprises the selection of the at least one of the header data options and the selection of the at least one of the parameter data options, and wherein the script provides instructions to display a particular advertisement on a search-results interface on a webpage.

16. The system of claim 15, wherein the advertising-campaign template further displays an option for the user to select an existing ad campaign or a new ad campaign.

17. The system of claim 15, wherein automatically generating the script further comprises:
receiving an indication that the one or more header data options or the one or more parameter data options has been changed; and
updating the script based on the changed header data options or the changed parameter data options.

18. The system of claim 15, wherein the processors are further operable with executing the instructions to receive input from a user comprising a third text string input into a third text input field of the plurality of text input fields that comprises text to be statically inserted into the particular advertisement.

19. The system of claim 15, wherein the parameter data options comprise one or more of: a model type, an inventory number, or a price.

20. The system of claim 15, wherein the advertising-campaign template is associated with a plurality of online advertisements, wherein each online advertisement is associated with the same online advertising campaign.
